(19) United States
(12) Patent Application Publication
(10) Pub. No.: US 2025/0196933 A1
(43) Pub. Date: Jun. 19, 2025

(54) REAR STRUCTURE OF VEHICLE BODY

(71) Applicants: Hyundai Motor Company, Seoul (KR); Kia Corporation, Seoul (KR)

(72) Inventors: HaeHoon Lee, Hwaseong-si (KR); SungWoong Ha, Hwaseong-si (KR)

(21) Appl. No.: 18/935,976

(22) Filed: Nov. 4, 2024

(30) Foreign Application Priority Data
Dec. 15, 2023 (KR) 10-2023-0182952

(51) Int. Cl. B62D 25/20; B62D 25/04; B62D 25/16; B62D 65/02

(52) U.S. Cl. CPC B62D 25/2027; B62D 25/04; B62D 25/16; B62D 25/2036; B62D 65/02

(57) ABSTRACT

An embodiment rear structure of a vehicle body includes a transverse extension member connected to both sides of a rear cross member and a back panel, which are connected to each other, a rear pillar inner lower member connected to a cross extension extending in an outward direction of the vehicle body on both sides of the transverse extension member and the rear cross member, a wheel house inner extension member connected to a quarter assembly and the rear pillar inner lower member, and an integrated extension member connected to the quarter assembly and connected to the rear pillar inner lower member and the wheel house inner extension member.

### CROSS-REFERENCE TO RELATED APPLICATIONS

This application claims the benefit of Korean Patent Application No. 10-2023-0182952, filed on Dec. 15, 2023, which application is hereby incorporated herein by reference.

### TECHNICAL FIELD

The present invention relates to a rear structure of a vehicle body.

### BACKGROUND

Typically, in order to secure the strength and collision performance of the entire vehicle, a rear pillar (also called a D pillar by a person of ordinary skill in the art) assembly is provided that is connected to the quarter assembly and rear floor panel at the rear of the vehicle body.

The design of the rear pillar assembly is an important factor in the torsional performance of the vehicle body.

Recently, the demand for environment-friendly vehicles such as electric vehicles and hydrogen vehicles is increasing, vehicles are becoming larger, and heavy objects such as battery assemblies are mounted at the rear of the vehicle body.

Therefore, in order to secure the torsional performance of the vehicle body while supporting the load of a high weight, it is most important to secure the joint strength of the rear of the vehicle body and the connection between the parts of the rear pillar assembly.

The information contained in this background section has been prepared to promote understanding of the background of embodiments of the invention and may include matters that are not already known prior art.

### SUMMARY

The present invention relates to a rear structure of a vehicle body. Particular embodiments relate to a rear structure of a vehicle body that strengthens the connection between parts at the rear of the vehicle body.

Embodiments of the present disclosure provide a rear structure of a vehicle body capable of securing joint strength and inter-component connection at the rear of the vehicle body.

A rear structure of a vehicle body according to an embodiment may include a transverse extension member connected to both sides of a rear cross member and a back panel connected to each other, a rear pillar inner lower member connected to a cross extension extending in an outward direction of the vehicle body on both sides of the transverse extension member and the rear cross member, a wheel house inner extension member connected to a quarter assembly and the rear pillar inner lower member, and an integrated extension member connected to the quarter assembly and connected to the rear pillar inner lower member and the wheel house inner extension member.

The rear structure according to an embodiment may further include a first box closed section formed by connecting the transverse extension member, the rear cross member, and the back panel.

The rear structure according to an embodiment may further include a second box closed section formed by connecting the rear pillar inner lower member and the integrated extension member, and a third box closed section formed by connecting the wheel house inner extension member and the integrated extension member.

The first box closed section, the second box closed section, and the third box closed section may be radially arranged from a connection point of the transverse extension member, the rear pillar inner lower member, and the wheel house inner extension member, which are connected to each other.

The first box closed section may be disposed along the vehicle width direction, the second box closed section may be disposed along the vertical direction, and the third box closed section may be disposed along the front to rear direction of the vehicle body.

The transverse extension member may include a first flange portion connected to an edge portion of the back panel connected to the rear cross member and to a rear floor panel and a first connection portion connected to the rear pillar inner lower member.

The rear pillar inner lower member may include a second flange portion connected to the wheel house inner extension member.

The rear pillar inner lower member may include a second connection portion connected to the cross extension and a third connection portion extending upward from the second connection portion and connected to the first connection portion.

The second connection portion and the third connection portion may be folded in multiple stages along the vertical direction.

The third connection portion may be connected to the first connection portion on three sides along the front to rear direction of the vehicle body, the width direction, and the vertical direction.

The wheel house inner extension member may include a third flange portion formed at the lower end to be connected to the quarter assembly and the rear pillar inner lower member along the front to rear direction of the vehicle body.

The wheel house inner extension member may include an inner protruding portion that protrudes in the inward direction of the vehicle body and is connected to the quarter assembly, the rear floor panel, and the rear pillar inner lower member.

An inner protruding portion formed in the wheel house inner extension member may protrude in the inward direction of the vehicle body and may be connected to the second connection portion and the third connection portion.

The transverse extension member may form a first box closed section together with the rear cross member and the back panel.

The second connection portion and the third connection portion may form a second box closed section together with the integrated extension member.

The inner protruding portion may form a third box closed section together with the integrated extension member.

A first assembly process may be performed in which the second connection portion is connected to the cross extension and the third connection portion is connected to the first connection portion while the transverse extension member, the rear pillar inner lower member, the wheel house inner extension member, and the quarter assembly are connected to each other.

After the first assembly process, a secondary assembly process may be performed in which the integrated extension member is connected to the rear pillar inner lower member and the wheel house inner extension member.

According to the rear structure of a vehicle body according to embodiments of the present invention, the joint rigidity and connection between parts of the rear body can be strengthened.

In addition, the effects that can be obtained or expected from embodiments of the present invention are directly or implicitly disclosed in the detailed description of the embodiments of the present invention. That is, various effects predicted according to embodiments of the present invention will be disclosed in the detailed description to be provided later.

### BRIEF DESCRIPTION OF THE DRAWINGS

Since these drawings are for reference in explaining exemplary embodiments of the present invention, the technical ideas of the embodiments of the present invention should not be interpreted as limited to the attached drawings.

FIG. 1 and FIG. 2 are perspective views illustrating a rear structure of a vehicle body according to an embodiment.

FIG. 3 and FIG. 4 are partially exploded perspective views illustrating the rear structure of a vehicle body according to an embodiment.

FIG. 5 is a perspective view illustrating a rear pillar applied to the rear structure of a vehicle body according to an embodiment.

FIG. 6 is a partially exploded perspective view illustrating a joining structure of a transverse extension member applied to the rear structure of a vehicle body according to an embodiment.

FIG. 7 is a cross-sectional view along line A-A of FIG. 5.

FIG. 8 is a partially exploded perspective view illustrating a connecting structure of a rear pillar inner lower member applied to the rear structure of a vehicle body according to an embodiment.

FIG. 9 is a partially exploded perspective view illustrating a connecting structure of a wheel house inner extension member applied to the rear structure of a vehicle body according to an embodiment.

FIG. 10 is a cross-sectional view along line B-B of FIG. 5.

FIG. 11 is a cross-sectional view along line C-C of FIG. 5.

FIG. 12 is a drawing for explaining the assembly process of the rear structure of a vehicle body according to an embodiment.

The following reference identifiers may be used in connection with the drawings to describe various features of embodiments of the present invention.
1: rear end assembly 2: quarter assembly
3: rear floor panel 4: wheel house member
5: rear cross member 6: back panel
7: rear pillar 9: cross extension
10: transverse extension member 11: first flange portion
13: first connection portion 15: first box closed section
21: rear pillar inner upper member 30: rear pillar inner lower member
31: second flange portion 33: second connection portion
35: third connection portion 50: wheel house inner extension member
51: third flange portion 53: inner protruding portion
70: integrated extension member 71: second box closed section
73: third box closed section S1: first assembly process
S2: secondary assembly process 100: rear structure of a vehicle body

It should be understood that the drawings referenced above are not necessarily drawn to scale, but rather present rather simplified representations of various preferred features illustrating the basic principles of embodiments of the present invention. For example, specific design features of embodiments of the present invention, including particular dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that a person having ordinary skill in the art to which the present invention pertains can easily implement the embodiments of the present invention. As those skilled in the art would realize, the described embodiments may be modified in various different ways, all without departing from the spirit or scope of the embodiments of the present invention.

The terminology used herein is for the purpose of describing specific embodiments only and is not intended to limit the disclosure. As used herein, singular forms are intended to also include plural forms, unless the context clearly indicates otherwise.

In addition, in the detailed description below, the names of the components are divided into first, second, etc. to distinguish them when the components are in a similar relationship, and the description below is not necessarily limited to that order.

As used herein, the terms ‘comprise’ and/or ‘comprising’ indicate the presence of specified features, integers, steps, operations, elements and/or components, but may also include one or more other features, integers, or steps. It should also be understood that this does not exclude the presence or addition of elements, operations, components, and/or groups thereof.

As used herein, the term ‘and/or’ includes any one or all combinations of one or more items listed in association.

In this specification, the term ‘connected’ indicates a physical relationship between two components in which the components are directly connected to each other by welding, rivets, self piercing rivet (SPR), flow drill screw (FDS), structural adhesive, etc. or indirectly connected through one or more intermediate components.

As used herein, ‘vehicle,’ ‘vehicular,’‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based purpose built vehicles (PBVs), hydrogen-powered vehicles, and other alternative fuel vehicles (e.g., other than petroleum fuel derived from resources).

Hereinafter, embodiments of the present invention will be described in detail with reference to the accompanying drawings.

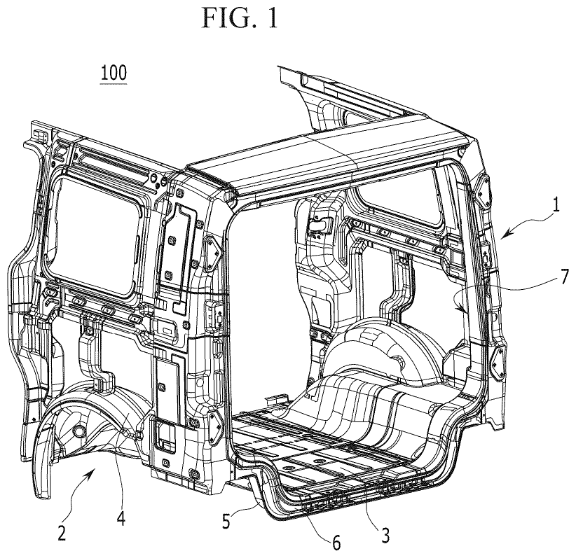

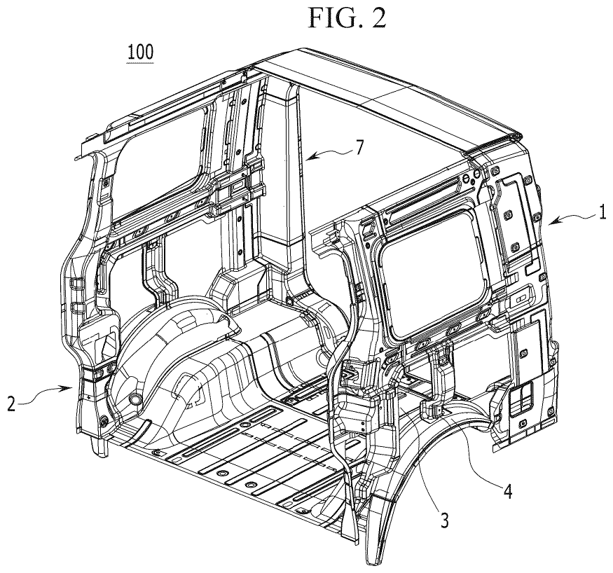

FIG. 1 and FIG. 2 are perspective views illustrating a rear structure of a vehicle body according to an embodiment.

Referring to FIG. 1 and FIG. 2, a rear structure 100 of a vehicle body according to an embodiment may be applied to, for example, a vehicle body of a purpose-based mobility vehicle (Purpose Built Vehicle: hereinafter referred to as a ‘PBV’).

The PBV may be utilized as an electric car-based life module vehicle that provides various customized services to users during the time it takes to move from the departure point to the destination.

As an example, the PBV can be manufactured as a 1 box type design with a wide interior space. Furthermore, the PBV may have facing-type seats applied to the interior space.

The vehicle body of this PBV is suitable for small-quantity production of various vehicle types with a small number of parts and can be manufactured in various shapes and sizes.

In this specification, the ‘front to rear direction of the vehicle body’ may be defined as the longitudinal direction of the vehicle body, the ‘vehicle width direction’ may be defined as the left-right direction of the vehicle body, and the ‘up-and-down direction’ or ‘vertical direction’ may be defined as the height direction of the vehicle body.

Furthermore, in this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The rear structure 100 of a vehicle body according to an embodiment may include a rear end assembly 1 connected to the rear part of the vehicle body along a front to rear direction, a vehicle width direction, and a vertical direction.

The rear end assembly 1 may be commonly applied to the rear part of a vehicle body of various vehicle types. Various vehicle types here mean various configurations of the rear end assembly 1. For example, it can be a hailing vehicle for transporting occupants, a delivery vehicle for transporting goods, and special vehicles such as ambulances.

The rear structure 100 according to an embodiment of the present invention includes a quarter assembly 2 connected to the rear end assembly 1. The quarter assembly 2 includes a wheel house member 4 connected to a rear floor panel 3.

Furthermore, the rear end assembly 1 includes a rear cross member 5 mounted along the vehicle width direction at the rear end of the rear floor panel 3. A back panel 6 is mounted on the rear cross member 5 along the vehicle width direction.

The rear end assembly 1 includes a rear pillar 7 which is configured to support the roof structure (not shown).

The rear structure 100 according to an embodiment of the present invention provides a structure capable of securing joint strength and inter-component connection at the rear of the vehicle body.

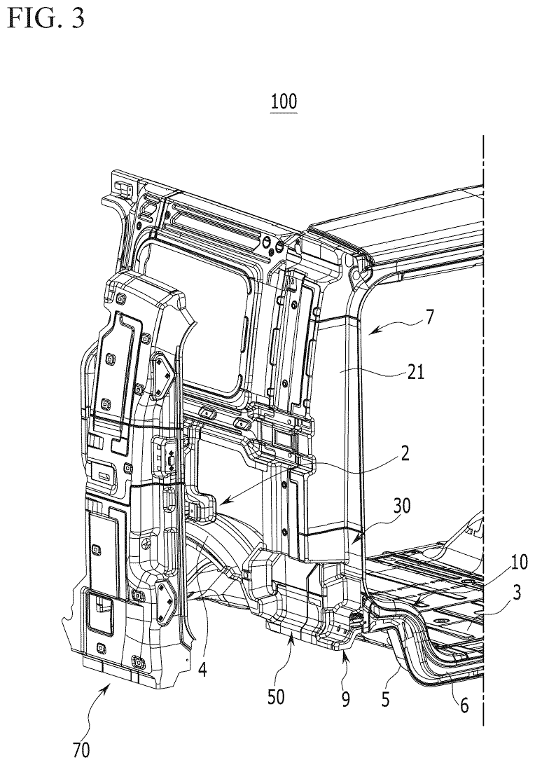

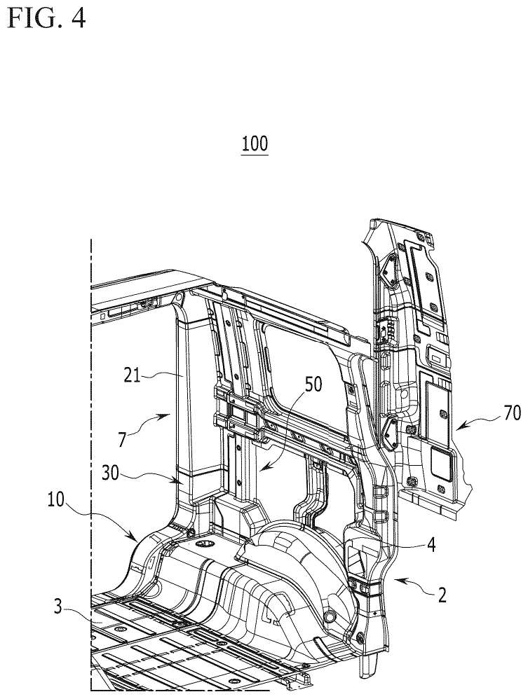

FIG. 3 and FIG. 4 are partially exploded perspective views illustrating the rear structure of a vehicle body according to an embodiment.

Referring to FIG. 3 and FIG. 4, the rear structure 100 according to an embodiment includes a transverse extension member 10, a rear pillar inner lower member 30, a wheel house inner extension member 50, and an integrated extension member 70.

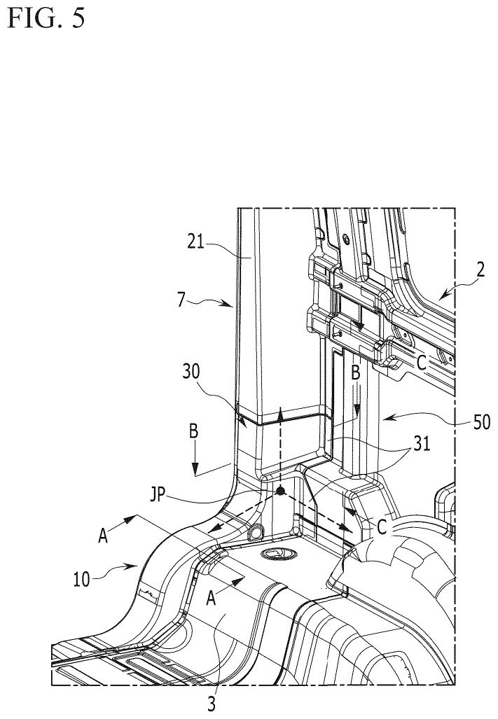

FIG. 5 is a perspective view illustrating a rear pillar applied to the rear structure of a vehicle body according to an embodiment.

Referring to FIG. 3 to FIG. 5, in an embodiment, the transverse extension member 10 is a member extending in the vehicle width direction from the rear pillar 7 and is connected to both sides of the rear cross member 5 and the back panel 6, which are connected to each other.

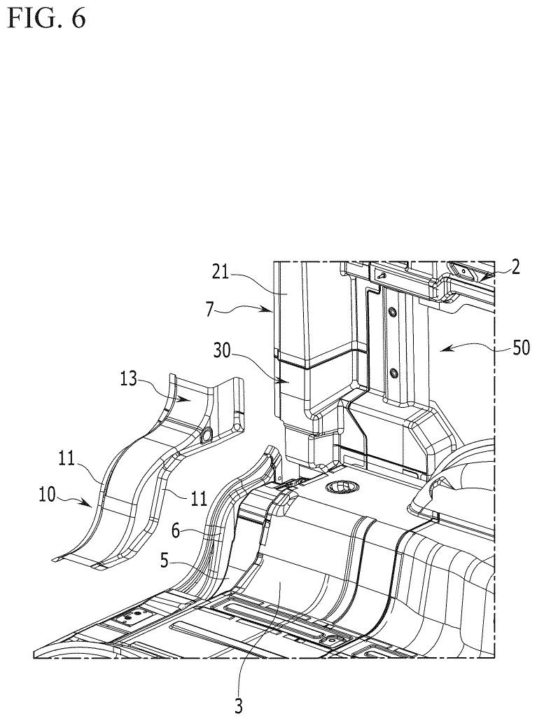

FIG. 6 is a partially exploded perspective view illustrating a joining structure of a transverse extension member applied to the rear structure of a vehicle body according to an embodiment.

Referring to FIG. 6, the transverse extension member 10 according to an embodiment includes a first flange portion 11 and a first connection portion 13.

The first flange portion 11 is formed on each side of the transverse extension member 10 in the vehicle width direction. The first flange portion 11 is connected to an edge portion of the back panel 6, which is connected to the rear cross member 5, and to the rear floor panel 3 by welding along the vehicle width direction.

The first connection portion 13 is formed in a shape corresponding to the rear pillar inner lower member 30 to be described later. The first connection portion 13 may be joined to the rear pillar inner lower member 30 by welding.

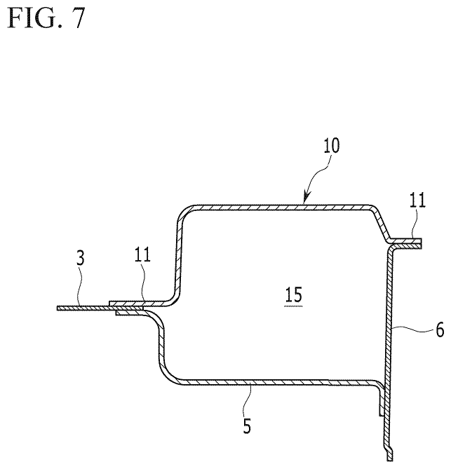

FIG. 7 is a cross-sectional view along line A-A of FIG. 5.

Referring to FIG. 6 and FIG. 7, an embodiment of the rear structure 100 further includes a first box closed section 15 connecting the transverse extension member 10, the rear cross member 5, and the back panel 6.

That is, the transverse extension member 10 may form the first box closed section 15 together with the rear cross member 5 and the back panel 6.

The first box closed section 15 is connected to the rear pillar inner lower member 30, which will be described later, and is arranged along the vehicle width direction.

Referring to FIG. 3 to FIG. 5, in an embodiment, the rear pillar inner lower member 30 is a member forming the lower portion of the rear pillar 7, is joined to the transverse extension member 10, and is connected to the wheel house inner extension member 50 to be described later.

In the drawing, drawing reference symbol 21 indicates a rear pillar inner upper member. The rear pillar inner upper member 21 is joined to the rear pillar inner lower member 30 and is connected to the quarter assembly 2.

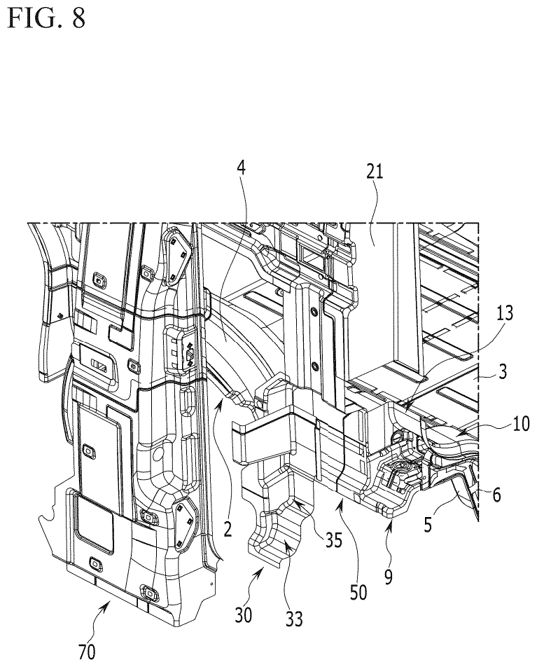

FIG. 8 is a partially exploded perspective view illustrating a connecting structure of a rear pillar inner lower member applied to the rear structure of a vehicle body according to an embodiment.

Referring to FIG. 5 and FIG. 8, the rear pillar inner lower member 30 according to an embodiment is connected to a cross extensions 9 extending in the outward direction of the vehicle body on both sides of the rear cross member 5.

The rear pillar inner lower member 30 includes a second flange portion 31, a second connection portion 33, and a third connection portion 35.

As shown in FIG. 5, the second flange portion 31 is formed at the front edge portion thereof and is connected to the wheel house inner extension member 50 to be described later.

As shown in FIG. 8, the second connection portion 33 is formed at the lower portion of the rear pillar inner lower member 30 and is connected to the cross extension 9 of the rear cross member 5 along the vehicle width direction.

And, the third connection portion 35 extends upward from the second connection portion 33 and is connected to the first connection portion 13 of the transverse extension member 10.

The second connection portion 33 and the third connection portion 35 are provided in a shape that is folded in multiple stages along the vertical direction, in one example.

The third connection portion 35 may be joined to the first connection portion 13 of the transverse extension member 10 by welding on three sides along the front to rear direction, the vehicle width direction, and the vertical direction of the vehicle body.

Referring to FIG. 3 to FIG. 5, in an embodiment, the wheel house inner extension member 50 is positioned on both sides of the rear structure 100 and is connected to the wheel house member 4 of the quarter assembly 2 along the front to rear direction of the vehicle body.

And, the wheel house inner extension member 50 is connected to the rear pillar inner lower member 30.

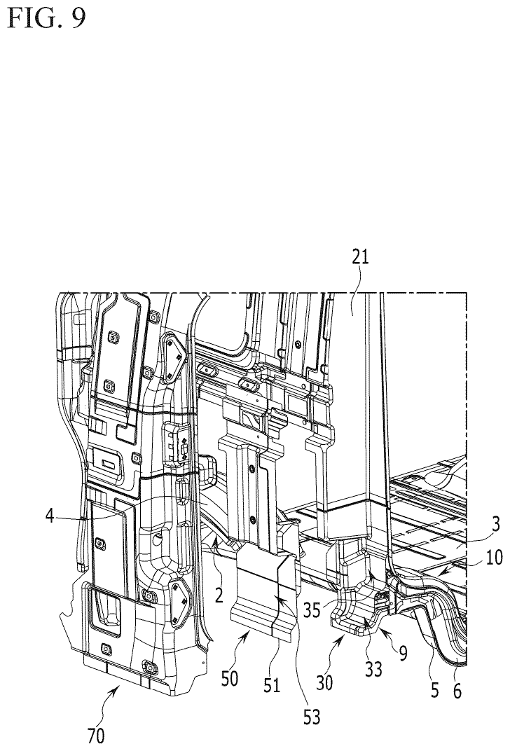

FIG. 9 is a partially exploded perspective view illustrating a connecting structure of a wheel house inner extension member applied to the rear structure of a vehicle body according to an embodiment.

Referring to FIG. 5 and FIG. 9, the wheel house inner extension member 50 according to an embodiment includes a third flange portion 51 and an inner protruding portion 53.

The third flange portion 51 is formed at the lower end of the wheel house inner extension member 50 to join with the quarter assembly 2 and the rear pillar inner lower member 30 along the front to rear direction of the vehicle body.

And, the inner protruding portion 53 extends upward from the third flange portion 51. The inner protruding portion 53 is formed to protrude in the vehicle body inward direction from the wheel house inner extension member 50. A person of ordinary skill in the art also calls the inner protruding portion 53 the ‘inner forming portion.’

The inner protruding portion 53 may be joined to the quarter assembly 2, the rear floor panel 3, and the rear pillar inner lower member 30 along the front to rear direction of the vehicle body. Furthermore, the inner protruding portion 53 may be joined with the second connection portion 33 and the third connection portion 35 of the rear pillar inner lower member 30.

Referring to FIG. 3 and FIG. 4, in an embodiment, the integrated extension member 70 is connected to the quarter assembly 2.

The integrated extension member 70 may be commonly applied to the rear vehicle body of a hailing vehicle and a delivery vehicle.

Referring to FIG. 3, FIG. 4, FIG. 8, and FIG. 9, the integrated extension member 70 according to an embodiment is connected to the rear pillar inner lower member 30 and the wheel house inner extension member 50.

The integrated extension member 70 may be joined as a single member to the rear pillar inner lower member 30 and the wheel house inner extension member 50 along the vehicle width direction.

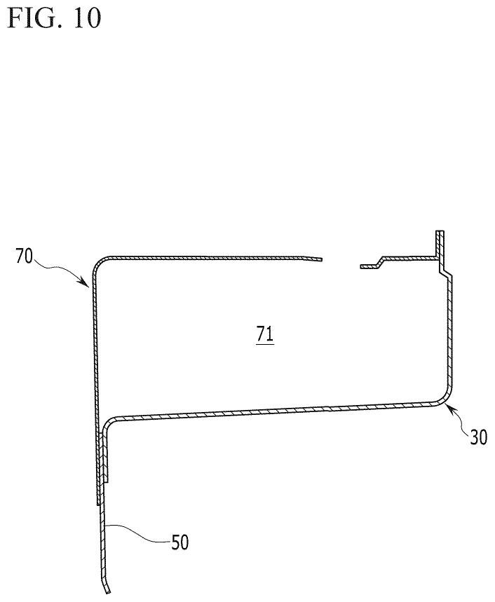

FIG. 10 is a cross-sectional view along line B-B of FIG. 5.

Referring to FIG. 3 and FIG. 10, the rear structure 100 according to an embodiment further includes a second box closed section 71 connecting the rear pillar inner lower member 30 and the integrated extension member 70.

That is, as shown in FIG. 8, the second connection portion 33 and the third connection portion 35 of the rear pillar inner lower member 30 may form the second box closed section 71 together with the integrated extension member 70.

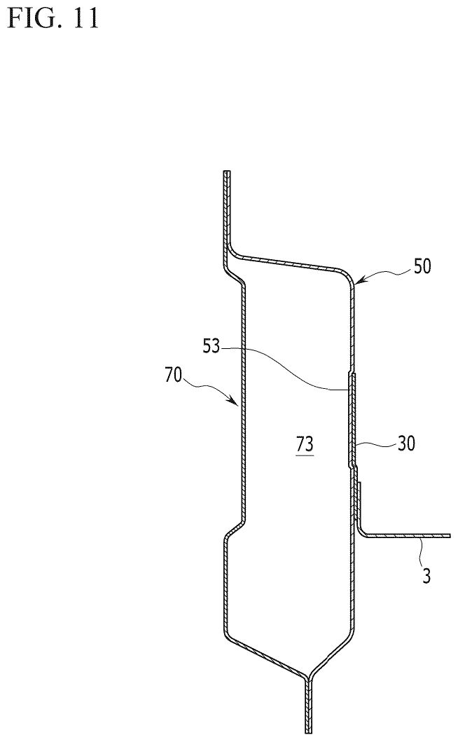

The second box closed section 71 is connected to the transverse extension member 10 and the wheel house inner extension member 50 and is arranged along the vertical direction. FIG. 11 is a cross-sectional view along line C-C of FIG. 5.

Referring to FIG. 3 and FIG. 11, the rear structure 100 according to an embodiment further includes a third box closed section 73 connecting the wheel house inner extension member 50 and the integrated extension member 70.

That is, as shown in FIG. 9, the inner protruding portion 53 of the wheel house inner extension member 50 may form the third box closed section 73 together with the integrated extension member 70.

The third box closed section 73 is connected to the rear pillar inner lower member 30 and is arranged along the front to rear direction of the vehicle body.

The first box closed section 15 as shown in FIG. 7, the second box closed section 71, and the third box closed section 73 as shown in FIG. 10 and FIG. 11, respectively, are arranged radially, as shown in FIG. 5.

The first box closed section 15, the second box closed section 71, and the third box closed section 73 may be radially arranged from a joint point JP of the transverse extension member 10, the rear pillar inner lower member 30, and the wheel house inner extension member 50.

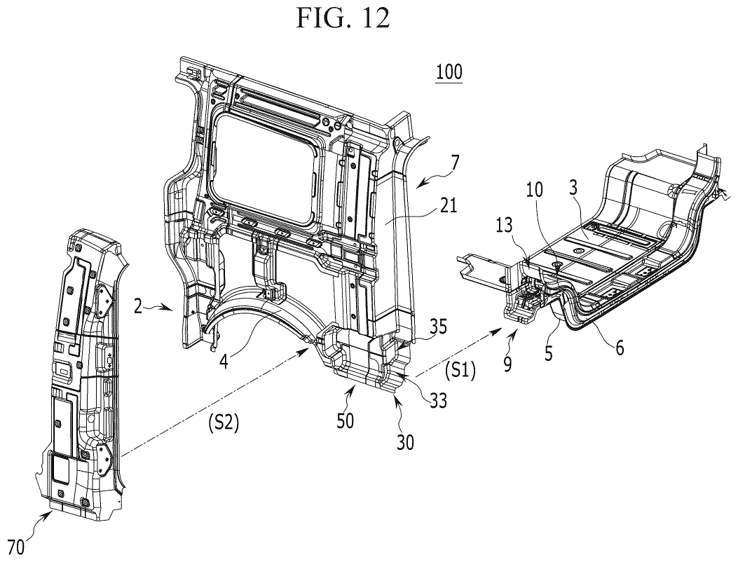

FIG. 12 is a drawing for explaining the assembly process of the rear structure of a vehicle body according to an embodiment.

Hereinafter, the assembly process and operation of the rear structure 100 according to an embodiment configured as described above will be described in detail, referring to FIG. 1 to FIG. 12.

Referring to FIG. 1 to FIG. 12, in an embodiment, the transverse extension member 10 is connected to each side of the rear cross member 5 and the back panel 6, respectively.

The transverse extension member 10 is connected to the edge portion of the back panel 6 and the rear floor panel 3 by welding along the vehicle width direction through the first flange portion 11 in a separate process.

Meanwhile, in an embodiment, the rear pillar inner upper member 21 and the rear pillar inner lower member 30, which are connected to each other, are connected to the quarter assembly 2 in another process.

The wheel house inner extension member 50 is joined to the quarter assembly 2 and connected to the second flange portion 31 of the rear pillar inner lower member 30.

Therefore, as described above, the transverse extension member 10, the rear pillar inner lower member 30, the wheel house inner extension member 50, and the quarter assembly 2 are connected to each other.

In this state, the rear pillar inner lower member 30 is connected to the cross extension 9 of the rear cross member 5 and the transverse extension member 10. And, the wheel house inner extension member 50 and the quarter assembly 2 are connected to the rear floor panel 3.

The second connection portion 33 of the rear pillar inner lower member 30 is connected to the cross extension 9. And, the third connection portion 35 of the rear pillar inner lower member 30 is connected to the first connection portion 13 of the transverse extension member 10.

The third connection portion 35 is connected on three sides along the front to rear direction of the vehicle body, the vehicle width direction, and the vertical direction by welding to the first connection portion 13 of the transverse extension member 10.

As shown in FIG. 12, after a series of first assembly processes Si as described above are performed, a secondary assembly process S2 is performed in which the integrated extension member 70 is connected to the rear pillar inner lower member 30 and the wheel house inner extension member 50.

Accordingly, according to an embodiment of the rear structure 100 assembled as described above, the first box closed section 15 connecting the transverse extension member 10, the rear cross member 5, and the back panel 6 is formed.

In addition, according to the rear structure 100 according to an embodiment assembled as described above, the second box closed section 71 is formed that connects the rear pillar inner lower member 30 and the integrated extension member 70, and the third box closed section 73 is formed that connects the wheel house inner extension member 50 and the integrated extension member 70.

Furthermore, according to the rear structure 100 according to an embodiment, the first box closed section 15, the second box closed section 71, and the third box closed section 73 as described above are radially connected along the front to rear direction of the vehicle body, the vehicle width direction, and the vertical direction.

Furthermore, according to an embodiment of the rear structure 100, the transverse extension member 10 and the rear pillar inner lower member 30 are connected by a three-sided bond.

Accordingly, according to the rear structure 100 according to an embodiment, the closed section coefficient in the front to rear direction of the vehicle body, the vehicle width direction, and the vertical direction may be increased, thereby improving the rear strength of the vehicle body and the connection between parts.

Additionally, according to the rear structure 100 according to an embodiment, the torsional performance of the vehicle can be improved by reinforcing the bonding strength and connectivity of the rear of the vehicle body.

Furthermore, the rear structure 100 according to an embodiment can improve the NVH performance of the vehicle and effectively disperse the collision load when the rear of the vehicle collides.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A rear structure of a vehicle body, the rear structure comprising:
a transverse extension member connected to both sides of a rear cross member and a back panel, which are connected to each other;
a rear pillar inner lower member connected to a cross extension extending in an outward direction of the vehicle body on both sides of the transverse extension member and the rear cross member;
a wheel house inner extension member connected to a quarter assembly and the rear pillar inner lower member; and
an integrated extension member connected to the quarter assembly and connected to the rear pillar inner lower member and the wheel house inner extension member.

2. The rear structure of claim 1, further comprising a first box closed section defined by connection of the transverse extension member, the rear cross member, and the back panel.

3. The rear structure of claim 2, further comprising:
a second box closed section defined by connection of the rear pillar inner lower member and the integrated extension member; and
a third box closed section defined by connection of the wheel house inner extension member and the integrated extension member.

4. The rear structure of claim 3, wherein the first box closed section, the second box closed section, and the third box closed section are radially arranged from a connection point of the transverse extension member, the rear pillar inner lower member, and the wheel house inner extension member, which are connected to each other.

5. The rear structure of claim 4, wherein:
the first box closed section is disposed along a vehicle width direction;
the second box closed section is disposed along a vertical direction; and
the third box closed section is disposed along a front to rear direction of the vehicle body.

6. The rear structure of claim 1, wherein the rear pillar inner lower member comprises a second flange portion connected to the wheel house inner extension member.

7. The rear structure of claim 1, wherein the wheel house inner extension member comprises a third flange portion disposed at a lower end to be connected to the quarter assembly and the rear pillar inner lower member along a front to rear direction of the vehicle body.

8. The rear structure of claim 1, wherein the wheel house inner extension member comprises an inner protruding portion that protrudes in an inward direction of the vehicle body and is connected to the quarter assembly, a rear floor panel, and the rear pillar inner lower member.

9. A rear structure of a vehicle body, the rear structure comprising:
a transverse extension member connected to both sides of a rear cross member and a back panel, which are connected to each other;
a rear pillar inner lower member connected to a cross extension extending in an outward direction of the vehicle body on both sides of the transverse extension member and the rear cross member;
a wheel house inner extension member connected to a quarter assembly and the rear pillar inner lower member; and
an integrated extension member connected to the quarter assembly and connected to the rear pillar inner lower member and the wheel house inner extension member; and
wherein the transverse extension member comprises:
a first flange portion connected to an edge portion of the back panel connected to the rear cross member and to a rear floor panel; and
a first connection portion connected to the rear pillar inner lower member.

10. The rear structure of claim 9, wherein the rear pillar inner lower member comprises:
a second connection portion connected to the cross extension; and
a third connection portion extending upward from the second connection portion and connected to the first connection portion.

11. The rear structure of claim 10, wherein the second connection portion and the third connection portion are folded in multiple stages along a vertical direction.

12. The rear structure of claim 10, wherein the third connection portion is connected to the first connection portion on three sides along a front to rear direction of the vehicle body, a width direction, and a vertical direction.

13. The rear structure of claim 10, further comprising an inner protruding portion disposed in the wheel house inner extension member, protruding in an inward direction of the vehicle body, and connected to the second connection portion and the third connection portion.

14. The rear structure of claim 13, wherein:
the transverse extension member defines a first box closed section together with the rear cross member and the back panel;
the second connection portion and the third connection portion define a second box closed section together with the integrated extension member; and
the inner protruding portion defines a third box closed section together with the integrated extension member.

15. A method of assembling a rear structure of a vehicle body, the method comprising:
connecting a transverse extension member to both sides of a rear cross member and a back panel, which are connected to each other, wherein a first flange portion of the transverse extension member is connected to an edge portion of the back panel and to a rear floor panel;
connecting a rear pillar inner lower member to a cross extension extending in an outward direction of the vehicle body on both sides of the transverse extension member and the rear cross member, wherein a first connection portion of the transverse extension member is connected to the rear pillar inner lower member;
connecting a wheel house inner extension member to a quarter assembly and the rear pillar inner lower member;
connecting an integrated extension member to the quarter assembly; and
performing a first assembly process in which a second connection portion of the rear pillar inner lower member is connected to the cross extension and a third connection portion of the rear pillar inner lower member, extending upward from the second connection portion, is connected to the first connection portion, in a state in which the transverse extension member, the rear pillar inner lower member, the wheel house inner extension member, and the quarter assembly are connected to each other.

16. The method of claim 15, wherein after performing the first assembly process, the method further comprises performing a secondary assembly process in which the integrated extension member is connected to the rear pillar inner lower member and the wheel house inner extension member.

17. The method of claim 16, wherein a first box closed section connecting the transverse extension member, the rear cross member, and the back panel is formed.

18. The method of claim 17, wherein:
a second box closed section is formed that connects the rear pillar inner lower member and the integrated extension member; and
a third box closed section is formed that connects the wheel house inner extension member and the integrated extension member.

19. The method of claim 18, wherein the first box closed section, the second box closed section, and the third box closed section are radially connected along a front to rear direction of the vehicle body, a vehicle width direction, and a vertical direction.

20. The method of claim 19, wherein the transverse extension member and the rear pillar inner lower member are connected by a three-sided bond.
